(19) United States
(12) Patent Application Publication
(10) Pub. No.: US 2026/0199930 A1
(43) Pub. Date: Jul. 16, 2026

(54) LIQUID SEALANT PACK WITH PERISTALTIC PUMP AND DISPENSING SYSTEM

(71) Applicant: LOUISIANA-PACIFIC CORPORATION, NASHVILLE, TN (US)

(72) Inventor: NEIL FREIDBERG, LEBANON, TN (US)

(21) Appl. No.: 19/451,465

(22) Filed: Jan. 16, 2026

Related U.S. Application Data
(60) Provisional application No. 63/745,859, filed on Jan. 16, 2025.

(51) Int. Cl. B05C 17/00; B05C 5/02; B05C 11/10

(52) U.S. Cl. CPC B05C 17/002; B05C 5/0254; B05C 11/1042

(57) ABSTRACT

A backpack and dispensing system for dispensing a caulking or liquid sealant. The pack or backpack houses one or more sealant tubes or cartridges which are in fluid communication with one or more peristaltic pumps. The sealant passes through a hose or tube by action of the corresponding pump on the hose or tube, and then to be applied through an application gun, which may be permanently or removably connected to the hose. The gun, which is controlled by a trigger, may use a special sealant tip, which may be removably attached to the gun.

This application claims priority to and benefit of U.S. Provisional App. No. 63/745,859, filed Jan. 16, 2025, which is incorporated herein in its entirety for all purposes by specific reference.

### FIELD OF INVENTION

This invention relates to a pack and dispensing system for dispensing a caulking or liquid sealant.

### BACKGROUND OF INVENTION

Sealing seams for an exterior bonded or integrated weather resistant barrier (WRB) sheathing panel is typically done with a sealing tape or a liquid sealant. At present, liquid sealant is applied using a two-handed caulking gun and squeegee/spreader. The user uses the caulking gun to apply the liquid sealant to the gap between the panels and the outer surface of the panels immediately adjacent or proximate to the gap. The user then must set down the caulking gun, and pick up and use the squeegee to spread the liquid sealant on the outer surface of the panels to the recommended thickness.

Frequently the user is applying the liquid sealant to a wall or roof structure above the ground, and often when standing on a ladder. The current application process requires the user to use both hands, and they thereby lose the three points of contact required for safe use of a ladder. In addition, the amount of liquid sealant in the tube inserted in the caulking gun typically runs out after about 24 feet, which requires frequent replacement and downtime, resulting in significant time and labor costs.

### SUMMARY OF INVENTION

In various exemplary embodiments, the present invention comprises a pack and dispensing system for dispensing a caulking or liquid sealant. As compared to prior art caulk and/or sealant applicators, the present invention allows the user to dispense a greater amount of caulk or liquid sealant before running out, thereby reducing downtime in dispensing and refilling.

The pack or backpack has an interior chamber or space in which it houses one or more sealant containers in fluid connection with the same or a corresponding peristaltic pump. The pump comprises a lobed rotational element that rotates and compresses a pump sealant tube element directionally against a fixed element so as to move sealant through the sealant tubes to be applied through an application gun or nozzle, which may be permanently or removably connected to the hose. The pump has two ports for connection of tube elements, one port for a tube extending from a sealant tube or container to the pump, and a second port for a tube extending from the pump to the application gun or nozzle.

The gun, which is controlled by a trigger (such as when the trigger touches a contact or button to start sealant flow), may use a special sealant tip, which may be removably attached to the gun housing (such as by a screw top and/or adapter plate). The sealant becomes activated when it contacts air, and remains in liquid form until it exits the tip.

### BRIEF DESCRIPTION OF THE DRAWINGS

FIGS. 1A and 1B show back and front views of a liquid sealant pack with internal insulated sealant container and peristaltic pump, in accordance with an exemplary embodiment of the present invention.

FIG. 2 shows a perspective view of the insulated container and pump with sealant hose and gun.

FIGS. 3A-B show close-up views of two embodiments of a container/bag with peristaltic pump system, FIG. 3A showing a closed system with an integrated container and pump, and FIG. 3B showing an open system with container/bag being detachable at a connector from the pump and/or hose.

FIG. 4 shows a cutaway view of the interior of an exemplary peristaltic pump.

FIG. 5 shows a view of a system with two containers connected to two pumps.

FIG. 6 shows a view of a battery connected to a pump.

FIG. 7 shows a view of a hose and dispenser tip.

### DETAILED DESCRIPTION OF EXEMPLARY EMBODIMENTS

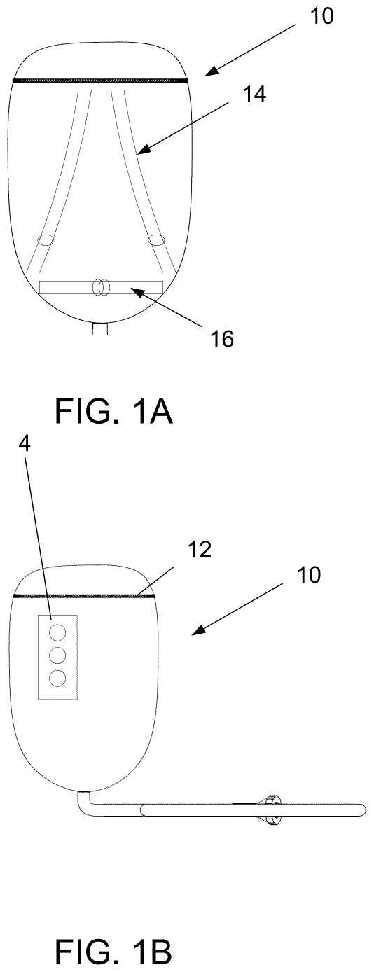

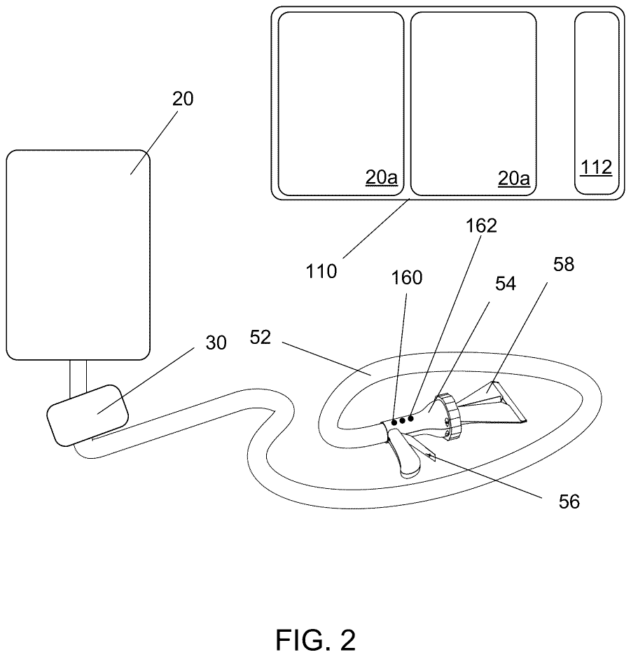

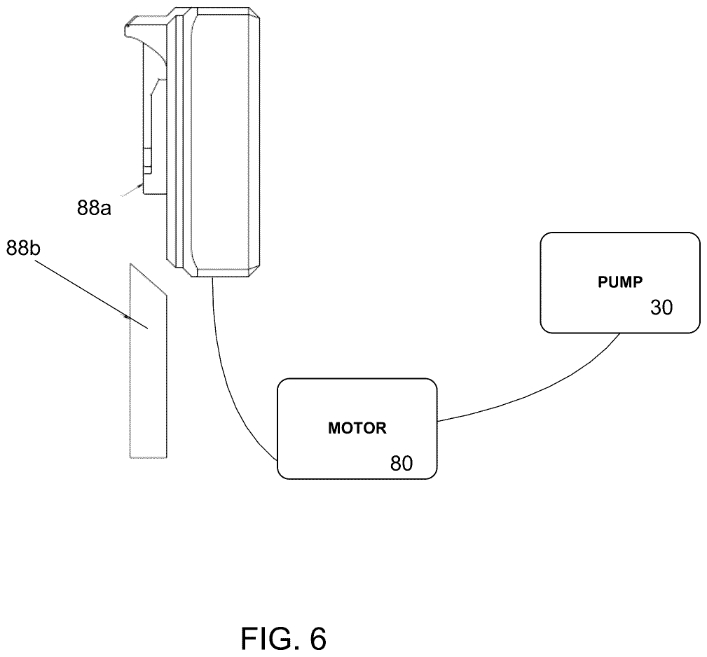

In various exemplary embodiments, as seen in FIGS. 1-7, the present invention comprises a pack and dispensing system for dispensing a caulking or liquid sealant. As compared to prior art caulk and/or sealant applicators, the present invention allows the user to dispense a greater amount of caulk or liquid sealant before running out, thereby reducing downtime in dispensing and refilling.

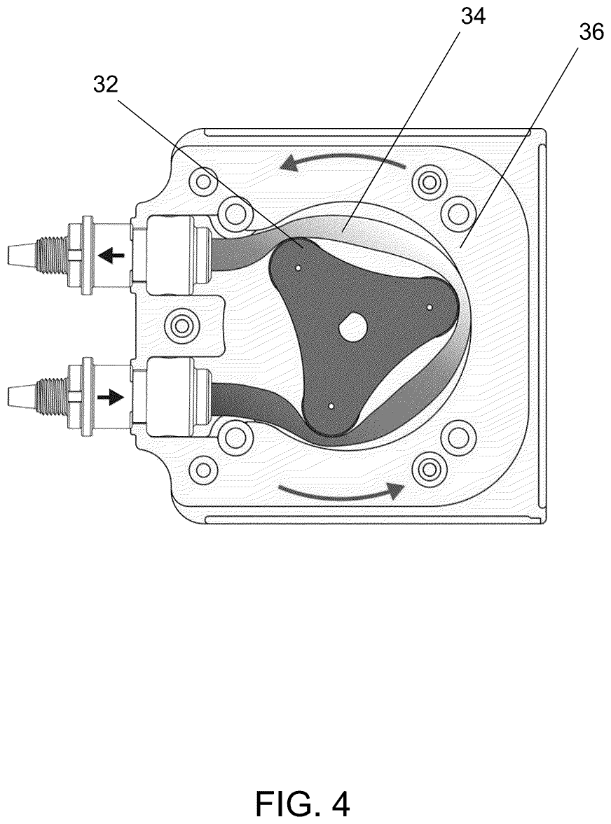

The pack or backpack 10 has an interior chamber or space in which it houses one or more sealant containers 20 in fluid connection with the same or a corresponding peristaltic pump 30. As seen in FIG. 4, the pump 30 comprises a lobed rotational element 32 that rotates and compresses a pump sealant tube element 34 directionally against a fixed element 36 so as to move sealant through the sealant tubes to be applied through an application gun or nozzle 54, which may be permanently or removably connected to the hose. FIG. 4 shows an embodiment where the pump has two ports for connection of tube elements, one port for a tube extending from a sealant tube or container to the pump, and a second port for a tube extending from the pump to the application gun or nozzle.

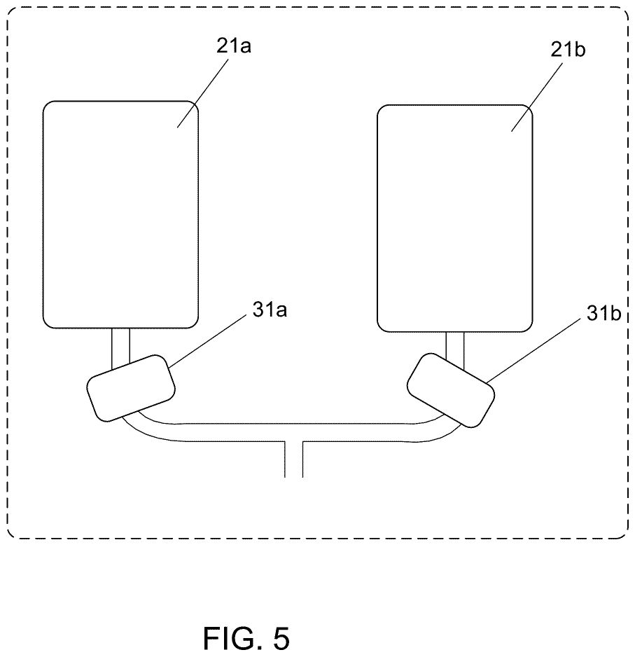

In some embodiments, the pack 20 may contain multiple containers 21a, b each to be connected to a single pump 30 consecutively, or each with their own pump 31a, b as shown in FIG. 5. As one container is exhausted of sealant, another in the pack may be connected to the to pump. When each has their own pump, they may be connected in turn as the container is exhausted to the hose leading to the gun. In an alternative embodiment, two or more containers and pumps may operate simultaneously in parallel, each providing sealant to a combined sealant stream, as seen in FIG. 5.

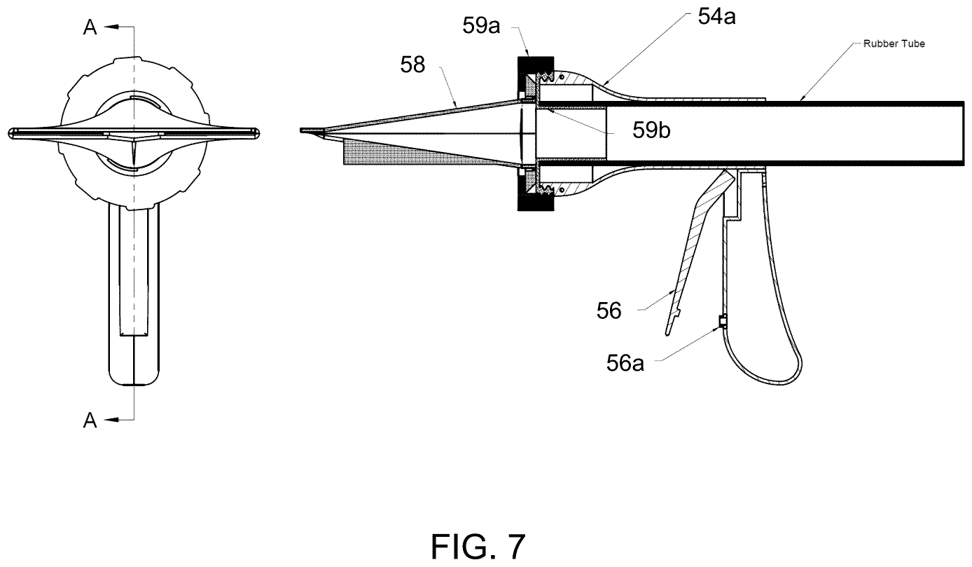

The gun 54, which is controlled by a trigger 56 (such as when the trigger touches a contact or button 56a to start sealant flow), may use a special sealant tip 58, which may be removably attached to the gun housing 54a (such as by a screw top 59a and/or adapter plate 59b). The sealant becomes activated when it contacts air, and remains in liquid form until it exits the tip. FIG. 7 shows a front and cross-sectional side view of a gun and flattened tip. A tip such as that shown is described in more detail in U.S. Pat. No. 12,350,702, Jul. 8, 2025, which is incorporated herein by specific reference in its entirety for all purposes.

The pack or backpack 10 is of general form and material as backpacks known in the prior art, with a body with a cover top (which may be attached in whole or in part by a zipper 12), with shoulder straps 14 which a user may use to carry over one or both shoulders. A belt 16 may be used to secure the bottom of the pack to the user's middle or core section, and to help transfer weight from the shoulders to the user's hips. The interior of the pack may be insulated and/or heated.

The peristaltic pump 30 is attached to a motor 80 (such as by a coupler 102 and coupling adapter 103). The motor may be secured in a motor housing 82, adjacent to or incorporated into a holder frame 74 configured to hold the one or more sealant containers. Sealant is drawn into the tube due to action of the pump, and flows through the pump and then through the hose or tube to the gun, as described above. The hose or tube may be rubber, plastic, or similar material.

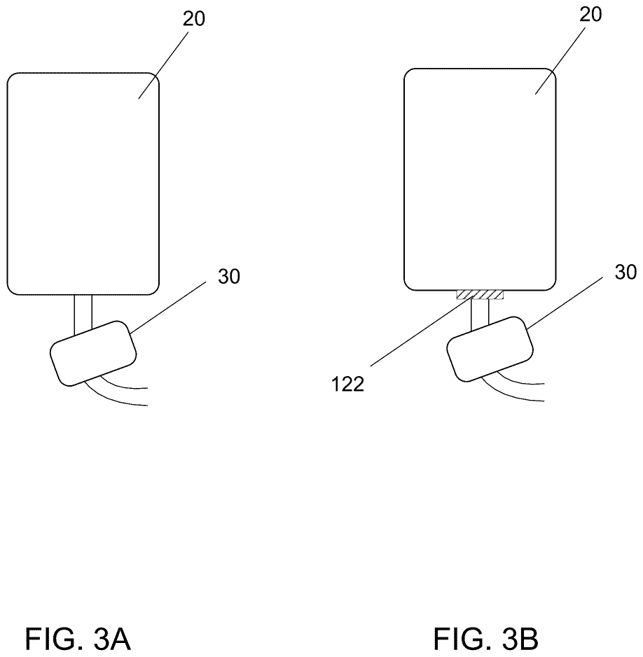

The pump and sealant container arrangement may be closed or open, as seen in FIGS. 3A and 3B. In an open arrangement, as seen in FIG. 3B, a port, clip or other connector 122 may be used to attach and detach the sealant container. The upstream tube leading to the pump from the sealant container may be clipped or closed off when the sealant container is replaced, or may be integrated with the container and removed with it. FIG. 3A shows a closed system where the container and pump are integrated. The container then is refilled as need through a sealable or closable opening or port.

The pack further may comprise a heating element 96. The heating element may be integrated with the container, or surrounding or adjacent to the container. The containers may be heated if the ambient temperature gets too low, thereby allowing the liquid sealant to be at proper application temperature. The containers and/or the pack itself may be insulated, which will help retain heat in the container or the interior of the pack, and/or protect the liquid sealant from temperature extremes.

In a further embodiment, a separate heating bag or container 110 may be used to hold and pre-warm the sealant containers 20a prior to use. In some embodiments, the bag is insulated and contains a heating element or pad 112. Power may be supplied by a battery or battery pack, or a standard plug and power block for connection to an external electrical receptacle.

In several embodiments, the pack further contains one or more batteries (which may be rechargable) or battery adapter 88a (to provide power from standard rechargable tool batteries 88b), electrically connected to provide power to the motor 80 and/or heaters. In one embodiment, certain batteries and/or adapters are designated for providing power to the motor, while others are designated for providing power to the heater.

Controls may be provided on the gun 54 and/or a control module 4a on the pack. The gun trigger or switch 56, when pulled, may activate the peristaltic pump to cause the flow of the liquid sealant, and thus act as an on/off switch. A button for reversing the direction of the motor and pump may be provided. Similarly, a button and/or temperature control may be provided for the heater.

The present invention thus allows a user to apply liquid sealant or caulk single-handedly (although two hands may be used, if desired) at the correct thickness (millage) and width, while avoiding frequent downtime to replace sealant cartridges or tubes.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A liquid sealant dispenser, comprising:
a backpack with an interior;
a sealant bag or container disposed in the interior of the backpack, said sealant bag or container containing a sealant fluid or liquid; and
a peristaltic pump in fluid communication with the sealant bag or container, said peristaltic pump comprising a rotational element that causes the sealant fluid or liquid to flow from the sealant bag or container through a dispensing tube or hose.

2. The dispenser of claim 1, further comprising:
a sealant application gun; and
a sealant hose running between the peristaltic pump and the sealant application gun.

3. The dispenser of claim 2, wherein the sealant application gun comprises a trigger and a removable sealant tip for applying the sealant fluid or liquid.

4. The dispenser of claim 2, wherein the sealant bag or container is removable and replaceable.

5. The dispenser of claim 1, wherein the backpack interior is insulated.

6. The dispenser of claim 1, wherein the backpack interior is heated.

7. The dispenser of claim 1, wherein the sealant bag or container is insulated.

8. The dispenser of claim 1, further comprising one or more batteries.

9. The dispenser of claim 1, further comprising a direction of rotation control, and a temperature control.

10. The dispenser of claim 2, further comprising a flattened tip disposed on an end of the sealant application gun.

11. The dispenser of claim 1, further comprising a second sealant bag or container disposed in the interior of the backpack.
